(19) United States
(12) Patent Application Publication
(10) Pub. No.: US 2005/0142406 A1
(43) Pub. Date: Jun. 30, 2005

(54) Fuel cell system and method of operating the same

(75) Inventors: Takeshi Obata, Tokyo (JP); Shin Nakamura, Tokyo (JP); Kenji Kobayashi, Tokyo (JP); Tsutomu Yoshitake, Tokyo (JP); Yoshimi Kubo, Tokyo (JP)

Correspondence Address: Norman P. Soloway;HAYES SOLOWAY P.C., 130 W. Cushing Street, Tucson, AZ, 85701, US

(73) Assignee: NEC Corporation

(21) Appl. No.: 10/934,963

(22) Filed: Sep. 3, 2004

(30) Foreign Application Priority Data
Sep. 4, 2003 (JP) P2003-313300

(51) Int. Cl. H01M 8/04; H01M 8/24

(52) U.S. Cl. 429/22; 429/13

(57) ABSTRACT

The present invention provides a fuel cell system capable of supplying a stable power. In a fuel cell system, a plurality of fuel cell groups which supply a power to an external load are mutually electrically connected in series, as well as electrically connected to the external load. At least one fuel cell group is selected out of the plurality of fuel cell groups, and the selected fuel cell group is electrically disconnected from the external load.

This application is based on Japanese patent application No. 2003-313300, the content of which is incorporated hereinto by reference.

### BACKGROUND OF THE INVENTION

1. Field of the Invention

The present invention relates to a fuel cell system and a method of operating the same.

2. Description of the Related Art

With the recent development of the information-oriented society, amount of information handled by electronic equipment such as a personal computer has been skyrocketing, resulting in a drastic increase of power consumption by electronic equipment. Especially in the field of portable type electronic equipments, the increase of power consumption because of an increase of processing capacity has become a critical issue. Currently a lithium ion secondary battery is generally used as a power source for such portable type electronic equipment, however an energy density of a currently available lithium ion secondary battery is already close to a theoretical limit. Consequently, in order to extend a continuous available time of portable type electronic equipment, a driving frequency of its CPU has to be designed under a certain limit to prevent further increase of the power consumption.

Under such a situation, replacing the lithium ion secondary cell with a fuel cell, which has a greater energy density, for use as a power source of the electronic equipment is expected to significantly extend the continuous available time of the portable type electronic equipment.

The fuel cell is provided with an anode, a cathode, and an electrolyte disposed therebetween. The anode and the cathode are supplied with a fuel and an oxidant, respectively, so that an electrochemical reaction takes place to thereby generate electricity. Hydrogen has been generally used as the fuel, however recently methanol has come to be focused on as an alternative, because of a low cost and ease in handling. For example a reformed methanol fuel cell in which the methanol is reformed to produce hydrogen, and a direct-type fuel cell which directly uses methanol as a fuel, are being aggressively developed.

In case of using the hydrogen as the fuel, a reaction according to the following chemical equation (1) takes place in the anode.
3H₂→6H⁺+6e⁻ (1)

In case of using the methanol as the fuel, a reaction according to the following chemical equation (2) takes place in the anode.
CH₃OH+H₂O→6H⁺+CO₂+6e⁻ (2)

In either case, a reaction in the cathode can be described as the chemical equation (3) given below.
3/2O₂+6H⁺+6e⁻→3H₂O (3)

The fuel cells can be classified into various types according to a nature of the electrolyte, among which an alkali type, a solid polymer type, a phosphoric acid type, a molten carbonate type, and a solid electrolyte type are the representative ones.

A fuel cell system includes a certain number of unit cells constituting an entire fuel cell according to a power consumption of an external load. An output of such unit cells lowers with the lapse of operating time. Accordingly, the plurality of unit cells are normally connected in series, so that an enhanced power is supplied to the external load. Therefore, once any of the plurality of unit cells fail, the entire system is adversely affected.

The decline of the output of the unit cell is considered to be caused by degradation of the cathode, resultant from catalyst poisoning of the cathode due to a crossover of the fuel from the anode side, or from so called a flooding. The flooding stands for a phenomenon that permeability of a reaction gas is disturbed, by water produced in the cathode during a power generation process, or water adjunctive to proton overflowing from the anode side.

A power unit provided with a fuel cell , which is disclosed in International Publication Number WO00/49673, automatically makes a bridge when one of a plurality of fuel cells mutually connected in series becomes defective. Such power unit can restrain a power loss at a minimal level even though one of the plurality of fuel cells connected in series should fail.

However, the cited literature provides a fuel cell system that only isolates a troubled fuel cell from the system, without any reference to a measure of preventing a decline of an output of the fuel cell, which should be taken before the fuel cell fails.

In view of the foregoing, it is an object of the present invention to provide a fuel cell system capable of supplying a stable power. Also, it is another object of the present invention to provide a fuel cell system that is compact in size yet highly reliable.

### SUMMARY OF THE INVENTION

According to the present invention there is provided a fuel cell system comprising: a plurality of fuel cell groups which supply a power to an external load; a selection unit which selects at least one fuel cell group out of the plurality of fuel cell groups; and a connector which electrically disconnects the fuel cell group selected by the selection unit from the external load, and electrically connects another fuel cell group to the external load. Here, the external load stands for a mobile phone, a laptop and other portable personal computer, a handy electric apparatus such as a PDA (Personal Digital Assistant), various types of camera, a navigation system, a portable audio player, and so forth.

Referring to the above invention, the fuel cell group may be provided with at least one unit cell of the fuel cell, or a plurality of unit cells. Also, the plurality of fuel cell groups may be mutually connected in series or in parallel. Connecting the plurality of fuel cell groups in series increases an output of the fuel cell system. Accordingly, even when the fuel cell system includes a fewer number of fuel cell groups, the fuel cell can supply a necessary power to an external load, thereby becoming downsizing.

Under such constitution, since the fuel cell system selects a portion of a plurality of fuel cell groups and electrically disconnects it from an external load, the unit cells constituting the fuel cell group that has been electrically disconnected from the external load can make a pause. These inactive unit cells permit recovery from catalyst poisoning in the cathode, which is a cause of degradation of the fuel cell, by a reaction between water in the cathode and surrounding air, while the unit cells make a pause. Also, heat of reaction produced from such reaction causes the water in the cathode to evaporate, thereby accelerating removal of the water from the cathode. This permits the fuel cell to restore its output. Accordingly, the fuel cell group can restore the output while in the inactive condition. Therefore, the fuel cell group can maintain a stable output unlike a case of long hours of continuous use, and resultantly a life span of the fuel cell group can be extended.

The fuel cell system according to the present invention may further comprise a storage unit which stores a process in formation on which the selection unit selects a fuel cell group to be electrically disconnected from the external load, so that the selection unit may select a fuel cell group to be electrically disconnected from the external load according to the process information stored in the storage unit.

In the fuel cell system according to the present invention, the storage unit may store an order in which the selection unit selects a fuel cell group, so that the selection unit may sequentially select a fuel cell group to be electrically disconnected from the external load according to the order stored in the storage unit.

In the fuel cell system according to the present invention, the selection unit may select a fuel cell group to be electrically disconnected from the external load according to the operating status of the plurality of fuel cell groups. Here, the selection unit may select a fuel cell group to be electrically disconnected from the external load either according to the operating status of each fuel cell group, or according to the operating status of an entirety of the plurality of fuel cell groups.

The fuel cell system according to the present invention may further comprise a monitoring unit which monitors an operating status of each individual fuel cell group, so that the selection unit may select a fuel cell group to be electrically disconnected from the external load according to the operating status provided by the monitoring unit. For example, the selection unit may select a fuel cell group that is generating a lowest output, to electrically disconnect from the external load. Also, the selection unit may sequentially select a fuel cell group to be electrically disconnected from the external load, out of those generating an output lower than a predetermined value.

In the fuel cell system according to the present invention, the monitoring unit may include a voltage measuring unit which measures an output voltage of each individual fuel cell group, so that the selection unit may select a fuel cell group to be electrically disconnected from the external load according to the output voltage measured by the voltage measuring unit.

The fuel cell system according to the present invention may further comprise: a monitoring unit which monitors an operating status of the plurality of fuel cell groups; and a decision unit which decides whether or not to electrically disconnect at least one fuel cell group from the external load according to the operating status provided by the monitoring unit, so that the selection unit may select a fuel cell group to be electrically disconnected from the external load when the decision unit has decided to electrically disconnect at least one fuel cell group from the external load.

The foregoing constitution permits securing a sufficient output required by an external load, and making a portion of the fuel cell groups inactive while an output is generated in excess of a requirement. As a result, the fuel cell system can stably keep supplying power to the external load, and a life span of the fuel cell system can be extended.

In the fuel cell system according to the present invention, the monitoring unit may include a current value measuring unit which measures a current value of a plurality of fuel cell groups, so that the decision unit may decide whether or not to electrically disconnect at least one fuel cell group from the external load, according to the current value measured by the current value measuring unit. Here, the integrated current value may be used as the current value.

In the fuel cell system according to the present invention, the monitoring unit may include a power measuring unit which measures a power being supplied to the external load by the plurality of fuel cell groups, so that the decision unit may decide whether or not to electrically disconnect at least one fuel cell group from the external load, according to the power measured by the power measuring unit.

The fuel cell system according to the present invention may further comprise an announcing unit which announces a monitoring result provided by the monitoring unit. The announcing unit may be an output terminal which outputs a signal toward an external device, a display device which shows the monitoring result, a speaker which audibly outputs the monitoring result, and so forth.

Such constitution facilitates a user to be aware of a monitoring result, and to take an appropriate measure according thereto. As a result, higher reliability can be granted to the fuel cell system.

The fuel cell system according to the present invention may further comprise a time keeping unit, so that the connector may electrically connect to the external load the fuel cell group that has been electrically disconnected therefrom, after a predetermined time since the fuel cell group was electrically disconnected from the external load.

Such constitution permits electrically disconnecting a portion of the plurality of fuel cell groups from the external load, inactivating that portion for a predetermined time, and then restoring it to active condition by electrically connecting it again to the external load. Accordingly, the corresponding fuel cell group can restore an output. Therefore, the fuel cell group can maintain a stable output unlike a case of long hours of continuous use, and resultantly a life span of the fuel cell group can be extended.

In the fuel cell system according to the present invention, in case where a plurality of unit cells is included in a fuel cell group, the unit cells may be mutually connected in series. Such constitution permits supplying a necessary power to the external load with a fewer number of unit cells, thereby facilitating miniaturization of the fuel cell system.

The fuel cell system according to the present invention may further comprise a time keeping unit, so that the selection unit may sequentially select a fuel cell group to be electrically disconnected from the external load, each time a predetermined time elapses.

In the fuel cell system according to the present invention, the plurality of fuel cell groups may be mutually connected in series, and the connector may include an auxiliary line provided in parallel to the plurality of fuel cell groups, and a selector switch which electrically connects another fuel cell group to the external load via the auxiliary line when the fuel cell group selected by the selection unit has been electrically disconnected from the external load.

The fuel cell system according to the present invention may further comprise an auxiliary power source provided for the auxiliary line, for supplying power to the external load. Such constitution permits employing the auxiliary power source in place of the fuel cell group that has been inactivated, or in addition to the plurality of fuel cell groups. Accordingly, necessary power can be stably supplied to the external load even when any of the fuel cell groups is inactivated. Further, for example when a greater power is temporarily required or when the fuel cell group has to be inactivated such as a replacement process thereof, the auxiliary power source can be likewise employed for stably supplying power to the external load. Here, another fuel cell group may serve as the auxiliary power source.

According to the present invention, there is provided a fuel cell system comprising a plurality of fuel cell groups which supply a power to an external load, and a monitoring unit which monitors an operating status of each individual fuel cell group.

Such constitution permits monitoring an operating status of each fuel cell group, and thereby identifying which fuel cell group has failed in case where the operating status of the fuel cell group has declined. Accordingly, necessary measures can be effectively taken such as inactivating the fuel cell group that has declined operating status, removing it from the fuel cell system or repairing, and so on. Consequently, reliability of the fuel cell system can be upgraded. Also, the fuel cell groups may respectively include a plurality of unit cells. In such a case, this constitution provides a more simplified structure and process than that in a case of monitoring each unit cell. As a result, a fuel cell system that is highly reliable and compact in size can be obtained.

In the fuel cell system according to the present invention, the monitoring unit may include a voltage measuring unit which measures an output voltage of each individual fuel cell group.

In the fuel cell system according to the present invention, the selection unit may include a selection acceptance unit which accepts a selection made by a user of the fuel cell group to be electrically disconnected from the external load. Such constitution permits intentionally inactivating the fuel cell group, for example when replacing the cell, thereby facilitating a maintenance work.

According to the present invention, there is provided a method of operating a fuel cell system comprising: selecting at least one fuel cell group out of a plurality of fuel cell groups which supply a power to an external load; electrically disconnecting from the external load the fuel cell group that has been selected in the step of selecting; and electrically connecting another fuel cell group to the external load.

Such method permits inactivating a unit cell of the fuel cell group that has been electrically disconnected from the external load, thereby enabling the fuel cell group to restore an output. Accordingly, the fuel cell group can maintain a stable output unlike a case of long hours of continuous use, and resultantly a life span of the fuel cell group can be extended.

In the method of operating a fuel cell system according to the present invention, the step of selecting the fuel cell group may include selecting a fuel cell group to be electrically disconnected from the external load according to a predetermined process.

In the method of operating a fuel cell system according to the present invention, the step of selecting the fuel cell group may include sequentially selecting a fuel cell group to be electrically disconnected from the external load according to a predetermined order.

The method of operating a fuel cell system according to the present invention may further comprise monitoring an operating status of each individual fuel cell group, and the step of selecting the fuel cell group may include selecting a fuel cell group to be electrically disconnected from the external load according to the operating status of each individual fuel cell group.

In the method of operating a fuel cell system according to the present invention, the step of monitoring the operating status of each individual fuel cell group may include measuring an output voltage of each fuel cell group, and the step of selecting the fuel cell group may include selecting a fuel cell group to be electrically disconnected from the external load according to the output voltage measured in the step of measuring the output voltage.

The method of operating a fuel cell system according to the present invention may further comprise monitoring an operating status of the plurality of fuel cell groups, and the step of selecting the fuel cell group may include selecting a fuel cell group to be electrically disconnected from the external load according to the operating status of the plurality of fuel cell groups.

The method of operating a fuel cell system according to the present invention may further comprise: monitoring an operating status of the plurality of fuel cell groups; and deciding whether or not to electrically disconnect at least one fuel cell group from the external load out of the plurality of fuel cell groups; and the step of selecting the fuel cell group may include selecting a fuel cell group to be electrically disconnected from the external load when it has been decided to electrically disconnect at least one fuel cell group from the external load in the step of deciding.

In the method of operating a fuel cell system according to the present invention, the step of monitoring the operating status may include measuring a current value of the plurality of fuel cell groups, and the step of deciding may include deciding whether or not to electrically disconnect at least one fuel cell group from the external load, according to the current value measured in the step of measuring the current value.

In the method of operating a fuel cell system according to the present invention, the step of monitoring the operating status may include measuring a power being supplied to the external load, and the step of deciding may include deciding whether or not to electrically disconnect at least one fuel cell group from the external load, according to the power measured in the step of measuring the power.

The method of operating a fuel cell system according to the present invention may further comprise announcing a monitoring result obtained in the step of monitoring the operating status.

The method of operating a fuel cell system according to the present invention may further comprise: detecting a lapse of a predetermined time after the fuel cell group has been electrically disconnected from the external load in the step of electricity disconnecting the fuel cell group from the external load; and electrically connecting the fuel cell group to the external load after the predetermined time has elapsed.

The method of operating a fuel cell system according to the present invention may further comprise detecting a lapse of a predetermined time after the fuel cell group has been electrically disconnected from the external load in the step of electrically disconnecting the fuel cell group from the external load, and the step of selecting the fuel cell group may include sequentially selecting a fuel cell group to be electrically disconnected from the external load each time the predetermined time elapses.

According to the present invention there is provided a method of operating a fuel cell system comprising monitoring an operating status of each individual fuel cell group included in the plurality of fuel cell groups which supply a power to the external load.

Since such method includes monitoring the operating status of each fuel cell group, it permits identifying which fuel cell group has failed in case where the operating status of the fuel cell group has declined. Accordingly, necessary measures can be effectively taken such as inactivating the fuel cell group that has declined operating status, removing it from the fuel cell system or repairing, and so on. Consequently, reliability of the fuel cell system can be upgraded. Also, the fuel cell groups may respectively include a plurality of unit cells. In such a case, this constitution provides a more simplified structure and process than that in a case of monitoring each unit cell. As a result, a fuel cell system that is highly reliable and compact in size can be obtained.

In the method of operating a fuel cell system according to the present invention, the step of monitoring the operating status may include measuring an output voltage of each individual fuel cell group.

The method of operating a fuel cell system according to the present invention may further comprise electrically connecting to an external load an auxiliary power source which supplies a power thereto.

The method of operating a fuel cell system according to the present invention may further comprise announcing the monitoring result obtained in the step of monitoring. Such method facilitates a user to be aware of the monitoring result, and to take an appropriate measure according thereto. As a result, higher reliability can be granted to the fuel cell system.

According to the present invention there is provided a program for execution of the foregoing method of operating a fuel cell system, applicable to a fuel cell system comprising a plurality of fuel cell groups which supply a power to an external load wherein the plurality of fuel cell groups can be electrically connected and disconnected to the external load. According to the present invention, there is provided a storage medium containing such program.

It is to be understood that any other possible combination of the foregoing constituents of the present invention, as well as a modification of the constituents or expressions thereof made by substituting a method, a device, a system, a computer program or a storage medium containing the computer program among one another, are included in the scope of the present invention.

As described throughout the preceding passages, the present invention provides a fuel cell system capable of supplying a stable power. Also, the present invention provides a fuel cell system that is compact in size yet highly reliable.

### BRIEF DESCRIPTION OF THE DRAWING

The above and other objects, features and advantages of the present invention will be apparent from the following detailed description of the preferred embodiments of the invention in conjunction with the accompanying drawings, in which:

FIG. 1 is a block diagram schematically showing a configuration of a first preferred embodiment of the fuel cell system according to the present invention;

FIG. 2 is a flowchart showing an operating process of a controller of the fuel cell system shown in FIG. 1;

FIG. 3 is a block diagram schematically showing a configuration of a second embodiment of the fuel cell system according to the present invention;

FIG. 4 is a flowchart showing an operating process of a controller of the fuel cell system shown in FIG. 3;

FIG. 5 is a fragmentary block diagram schematically showing a configuration of a third embodiment of the fuel cell system according to the present invention;

FIG. 6 is a flowchart showing an operating process of a controller of the fuel cell system shown in FIG. 5;

FIG. 7 is a flowchart showing a process of a fuel cell switching operation included in FIG. 6;

FIG. 8 is a flowchart showing a process of a fuel cell switching operation in a fourth embodiment of the fuel cell system according to the present invention;

FIG. 9 is a fragmentary block diagram schematically showing a configuration of a fifth embodiment of the fuel cell system according to the present invention;

FIG. 10 is a flowchart showing an operating process of a controller of the fuel cell system shown in FIG. 9;

FIG. 11 is a flowchart showing a process of a fuel cell switching operation included in FIG. 10;

FIG. 12 is a block diagram schematically showing a configuration of a sixth embodiment of the fuel cell system according to the present invention;

FIG. 13 is a flowchart showing an operating process of a controller of the fuel cell system shown in FIG. 12; and

FIG. 14 is a fragmentary block diagram schematically showing a configuration of a seventh embodiment of the fuel cell system according to the present invention.

### DESCRIPTION OF THE PREFERRED EMBODIMENTS

Now embodiments of the present invention will be described referring to the accompanying drawings. Hereunder, constituents employed in common are given an identical numeral in all the drawings, and detailed description of such constituents may be omitted as the case may be.

First Embodiment

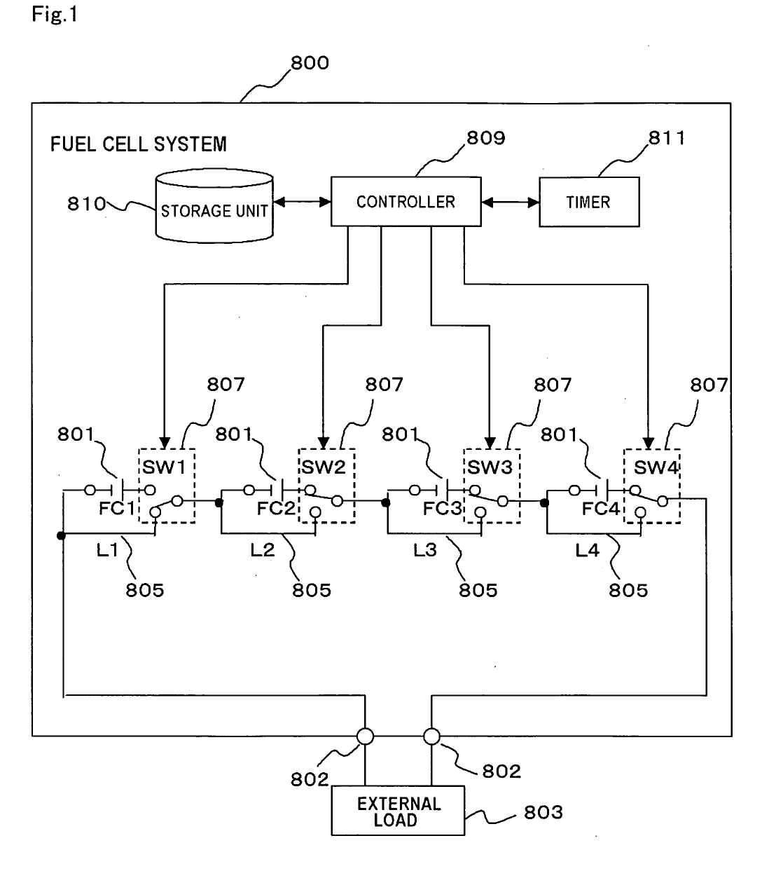

FIG. 1 is a block diagram schematically showing a configuration of a first embodiment of the fuel cell system according to the present invention.

As shown in FIG. 1, the fuel cell system 800 includes a plurality of fuel cell groups 801 mutually electrically connected in series. The fuel cell groups 801 are electrically connected in series to an external load 803 via terminals 802, to supply a power to the external load 803.

The fuel cell groups 801 respectively include at least one unit cell of the fuel cell. The number of the unit cells included in the fuel cell group 801 does not have to be the same. In case where the fuel cell group 801 includes a plurality of unit cells, those unit cells are mutually electrically connected in series. Accordingly, a fewer number of unit cells can supply a necessary power to the external load 803, and the fuel cell system 800 can therefore be made smaller in size. The fuel cell groups 801, which are respectively designated as ‘FC1’, “FC2”, “FC3” and “FC4” in FIG. 1, will be hereinafter designated as FCi referring to an i-th fuel cell group (i=1 to N, where N is the number of fuel cell groups, which may be four as shown in FIG. 1).

In this embodiment, the unit cell is provided with an anode, a cathode and a solid electrolyte disposed therebetween. The anode and the cathode are supplied with a fuel and an oxidant, respectively, so that an electrochemical reaction takes place to thereby generate electricity. The unit cell may be a direct type fuel cell in which a liquid fuel is supplied to the anode. Applicable fuels include methanol, ethanol, dimethylether or other alcohols, and an organic liquid fuel such as a hydrocarbon including a cycloparaffin. An organic liquid fuel may be used in a form of solution. As the oxidant ambient air may be employed, while an oxygen gas may be employed. Also, the unit cell that works under a normal temperature is preferably employed.

Also, the fuel cell system 800 includes a plurality of auxiliary line 805 disposed in parallel to each of the fuel cell groups 801, and a plurality of selector switches 807 which switches a connection between the fuel cell group 801 and the external load 803 to the auxiliary line 805. While four each of fuel cell groups 801, auxiliary line 805 and selector switches 807 are provided in this embodiment, the present invention is not limited to this constitution.

Also, four auxiliary lines 805, which are respectively designated as “L1”, “L2”, “L3” and “L4” in FIG. 1, will be hereinafter designated as “Li” referring to the auxiliary line of an i-th fuel cell group FCi. Likewise, four selector switches 807, which are respectively designated as “SW1”, “SW2”, “SW3” and “SW4” in FIG. 1, will be hereinafter designated as “SWi” referring to the selector switch of an i-th fuel cell group FCi.

For the selector switch 807, a relay may be employed (for example, Type JW2SN manufactured by Matsushita Electric Works, Ltd.). A power for driving the selector switch 807 may be supplied by one or more of the fuel cell groups 801. Also, the power for driving the selector switch 807 may be supplied by an auxiliary power source (not shown), such as a lithium ion secondary cell or an electric double layer capacitor.

Further, the fuel cell system 800 includes a controller 809 which controls an operation of the fuel cell group 801, a storage unit 810 which stores an operating process of the fuel cell system 800, and a timer 811. The controller 809 may be a CPU (Central Processing Unit) or an IC (Integrated Circuit), which operates according to a process preprogrammed and stored in the storage unit 810. The timer 811 may be an internal timer provided in the controller 809, otherwise an external timer may be employed. The timer 811 has a timekeeping function, by which to output a signal to the controller 809 when a predetermined time has elapsed. The controller 809 controls an operation of the fuel cell group 801 according to the signal output by the timer 811.

In the following passages, a process will be described wherein the controller 809 selects the fuel cell group 801 out of the plurality of fuel cell groups 801 to inactivate that fuel cell group 801 for a predetermined time.

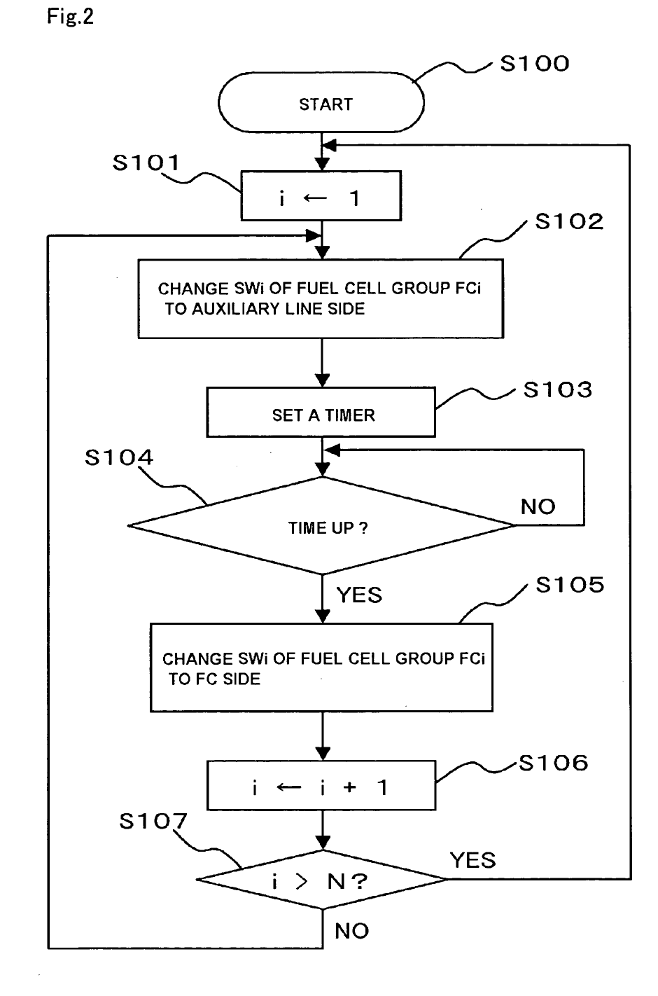

FIG. 2 is a flowchart showing an operating process of a controller 809 of the fuel cell system 800.

Firstly, when the system is activated (S100), 1 is set in i by the controller 809, as an ID number of the fuel cell group 801 (S101). Then a selector switch SWi of an i-th fuel cell group FCi is changed to the auxiliary line side (S102). Instruction is given to the timer 811 to start measuring the time, so that the timer 811 starts to measure a predetermined time (S103). The controller 809 monitors the timer 811 (S104), and once the predetermined time has elapsed (YES of S104), the selector switch SWi of the i-th fuel cell group FCi is changed to the fuel cell group side (S105).

Thereafter, i is incremented (S106), and the new value i is examined whether it is within the number N of the fuel cells (S107). In case of i is more than N (YES of S107), the control is returned to the step S101, so that 1 is set as i. On the other hand, in case of i is not more than N (NO of S107), the process returns to the step S102.

Now an operation of the fuel cell system 800 constituted as above in this embodiment will be described hereinafter referring to FIGS. 1 and 2.

As shown in FIG. 2, once the system is activated (S100), the controller 809 defines as i=1 (S101). Then the first fuel cell group FC1 is selected as the one to be first inactivated, and the selector switch SW1 is changed to the auxiliary line L1 side (S102). The state shown in FIG. 1 represents a situation where the fuel cell group FC1 is inactivated. After the fuel cell group FC1 is held inactive for a predetermined time (S103, S104), the selector switch SW1 is changed to the fuel cell group FC1 side, so that the first fuel cell group FC1 is restored to active condition (S105).

At this stage the controller 809 defines as i=2 (S106), by which the second fuel cell group FC2 is selected as the one to be inactivated, and the selector switch SW2 is changed to the auxiliary line L2 side (S102). After the fuel cell group FC2 is held inactive for a predetermined time (S103, S104), the selector switch SW2 is changed to the fuel cell group FC2 side, so that the second fuel cell group FC2 is restored to active condition (S105).

Similar operations are repeated with 3 and 4 as the i, i.e. with respect to the third and the fourth fuel cell groups FC3 and FC4 to inactivate them one after another, and then the controller 809 sets as i=1 to resume the foregoing process. Such arrangement permits selecting a fuel cell group in the sequence from the first fuel cell group FC1 to the fourth fuel cell group FC4, and inactivating them in the same sequence.

As described above, since the fuel cell system 800 in this embodiment is operated to select a portion of the fuel cell groups 801 and electrically disconnects it from the external load 803, the unit cells constituting the fuel cell group 801 that has been disconnected can be inactivated. The remaining portion of the fuel cell groups 801 are mutually connected in series, therefore the fuel cell system 800 can maintain a sufficient output even when one of the fuel cell groups 801 is inactivated.

Making the unit cells constituting the fuel cell group 801 inactive permits removal of methanol crossing over to the cathode because of a reaction between water in the cathode and surrounding air, and hence recovery from catalyst poisoning. Also, heat produced from the reaction that removes methanol causes the water in the cathode to evaporate, thereby accelerating removal of the water from the cathode. This permits the fuel cell to restore its output. In case where the fuel cell group 801 is continuously activated, the catalyst in the cathode cannot be recovered from poisoning, and besides water that has been produced in the cathode reins unremoved while the fuel cell group 801 is operating. Consequently, the fuel cell system 800 becomes prone to degrade. However, the fuel cell system 800 in this embodiment sequentially inactivates the plurality of fuel cell groups 801, thereby recovering from catalyst poisoning and removing water from the cathode and thus restoring an output of the respective fuel cell groups 801. As a result, the fuel cell system 800 can maintain a stable output, thereby extending its life span.

Further, in this embodiment the fuel cell groups are sequentially inactivated from the first one, while the fuel cell groups may be inactivated in a predetermined order. Also, the system may store the ID number i of the fuel cell group that has been inactivated during the last cycle, so that once the system resumes the activity the (i+1)th fuel cell group and the subsequent ones are sequentially inactivated. Further, while one fuel cell group out of the four is inactivated in this embodiment, a plurality of fuel cell groups may be inactivated at a time, for example two fuel cell groups out of the four. Also, an inactive period of the fuel cell group does not have to be constantly equal, but may be modified according to the situation. In a word, the number of fuel cell groups to be inactivated and an inactive period may be adjusted according to a status of the external load 803. For example, the external load 803 may require a higher power in a start-up phase, while a lower power may be sufficient in a standby status. Therefore, an adjustment may be suitably made so that a necessary power may be replenished according to such nature.

It is a matter of course that such adjustment can be performed as desired, by a program for operating the controller 809.

Furthermore, in this embodiment the selector switch is changed to the fuel cell side or the auxiliary line side by an instruction of the controller 809, according to a preprogrammed process. However, the system may alternatively accept an instruction from a user to turn the selector switch. In this case, an operational program for inputting the instruction to the controller 809 may be provided, otherwise an external selector switch (not shown) may be provided for directly manipulating the selector switch without involving the controller 809. Such constitution permits intentionally inactivating a fuel cell group, for example when replacing the cell, thereby facilitating a maintenance work.

Second Embodiment

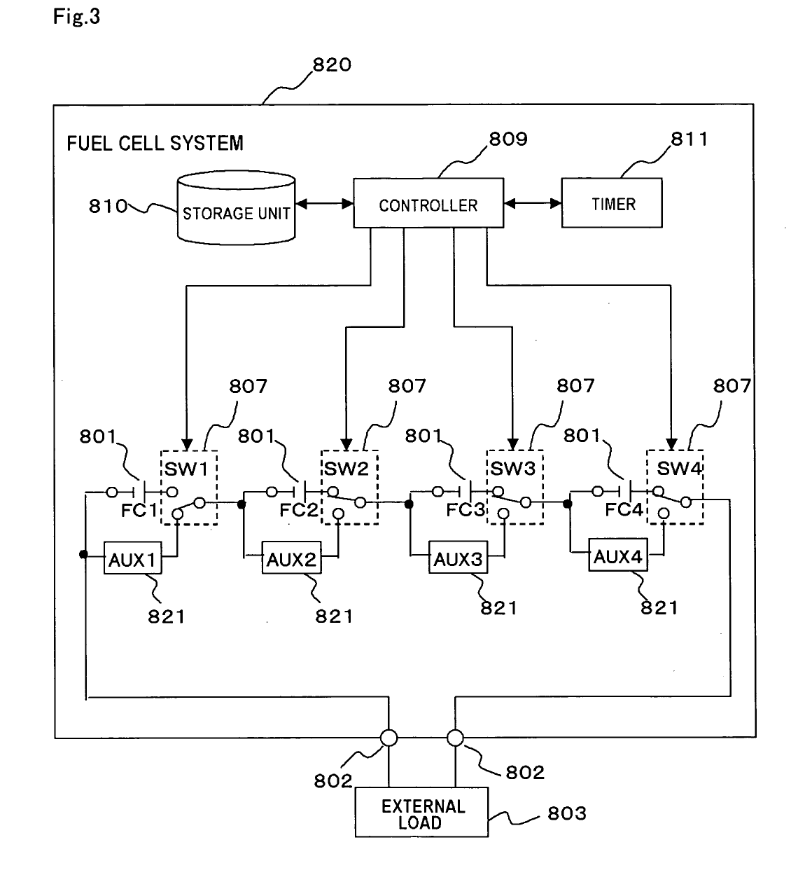

FIG. 3 is a block diagram schematically showing a configuration of a second embodiment of the fuel cell system according to the present invention. This embodiment is different from the first embodiment in that an auxiliary power source 821 is provided for each fuel cell group 801, for a substitutional use while the fuel cell group 801 is inactivated.

The fuel cell system 820 in the second embodiment includes four auxiliary power sources 821. The four auxiliary power sources 821, which are respectively designated by “AUX1”, “AUX2 ”, “AUX3” and “AUX4” in FIG. 3, will be hereinafter designated as “AUXi” to designate an i-th auxiliary power source (i=1 to N, where N is the number of fuel cell groups, which may be four as shown in FIG. 3).

The auxiliary power source 821 may be constituted of for example a lithium ion secondary cell or an electric double layer capacitor. Here, while four auxiliary power sources 821 are provided in this embodiment, the present invention is not limited to this constitution and for example, just one auxiliary power source 821 may be provided for the four fuel cell groups 801. The auxiliary power source 821 may be a fuel cell group, as will be described later.

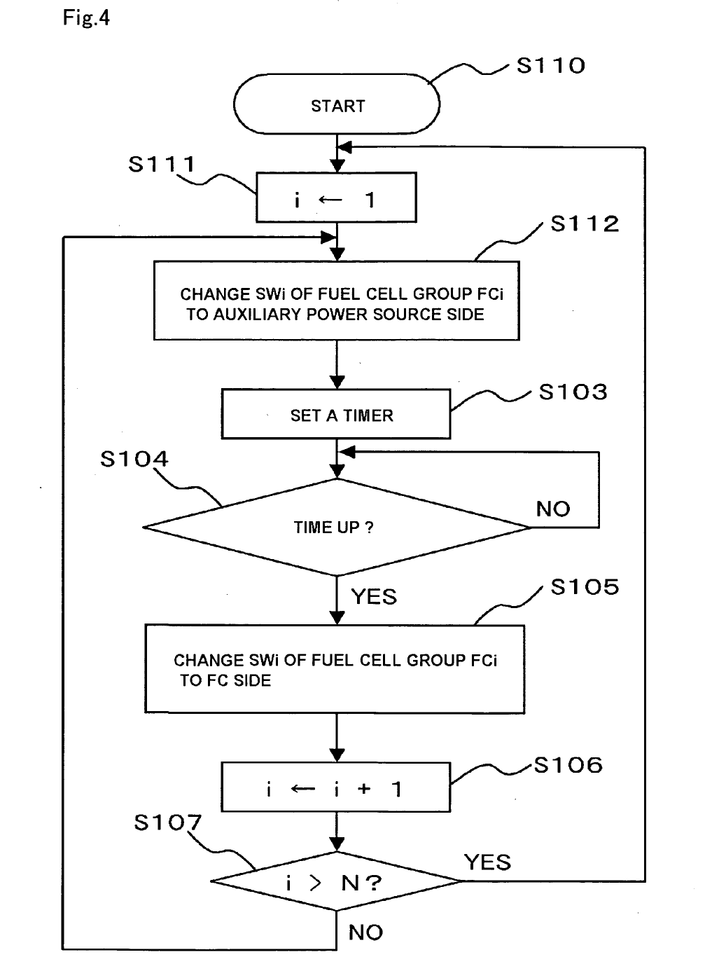

FIG. 4 is a flowchart showing an operating process of a controller of the fuel cell system of FIG. 3.

The process shown in FIG. 4 is different from that of the first embodiment described referring to FIG. 2, in that a step S112 is replaced for the step S102 of FIG. 2. At the step S112, the selector switch SWi of the i-th fuel cell group FCi is changed to the auxiliary power source side.

An operation of the fuel cell system 820 constituted as above in this embodiment will be described referring to FIGS. 3 and 4.

As shown in FIG. 4, once the system is activated (S110), the controller 809 defines as i=1 (S111). Then the first fuel cell group FC1 is selected as the one to be first inactivated, and the selector switch SW1 is changed to the auxiliary power source AUX1 side (S112). The state shown in FIG. 3 represents a situation where the fuel cell group FC1 is inactivated and the auxiliary power source AUX1 is activated. After the fuel cell group FC1 is held inactive for a predetermined time (S103, S104), the selector switch SW1 is changed to the fuel cell group FC1 side, so that the first fuel cell group FC1 is restored to active condition (S105). At this stage the controller 809 defines as i=2 (S106), by which the second fuel cell group FC2 is selected as the one to be inactivated, and the selector switch SW2 is changed to the auxiliary power source AUX2 side (S112). After the fuel cell group FC2 is held inactive for a predetermined time (S103, S104), the selector switch SW2 is changed to the fuel cell group FC2 side, so that the second fuel cell group FC2 is restored to active condition (S105).

Similar operations are repeated with 3 and 4 as the i, i.e. with respect to the third and the fourth fuel cell groups FC3 and FC4 to inactivate them one after another, and then the controller 809 sets as i=1 to resume the foregoing process. Such arrangement permits selecting a fuel cell group in the sequence from the first fuel cell group FC1 to the fourth fuel cell group FC4, and inactivating them in the same sequence for a predetermined time.

As described above, since the fuel cell system 820 in this embodiment is operated to select a portion of the fuel cell groups 801 and electrically disconnects it from the external load 803, the unit cells constituting the fuel cell group 801 that has been disconnected can be inactivated. Also, the auxiliary power source 821 can be employed as a substitute for the inactive fuel cell group 801, therefore the fuel cell system 820 can maintain a sufficient output even when one of the fuel cell groups 801 is inactivated.

Inactivating the unit cells constituting the fuel cell group 801 permits removal of methanol crossing over to the cathode because of a reaction between water in the cathode and surrounding air, and hence recovery from catalyst poisoning in the cathode. Also, heat produced from the reaction that removes methanol causes the water in the cathode to evaporate, thereby accelerating removal of the water from the cathode. This permits the fuel cell to restore its output. In case where the fuel cell group 801 is continuously activated, the catalyst in the cathode cannot be recovered from poisoning, and besides water that has been produced in the cathode reins unremoved while the fuel cell group 801 is operating. Consequently, the fuel cell system 820 becomes prone to degrade. However, the fuel cell system 820 in this embodiment sequentially inactivates the plurality of fuel cell groups 801, thereby recovering from catalyst poisoning or removing water from the cathode and thus restoring an output of the respective fuel cell groups 801. As a result, the fuel cell system 820 can maintain a stable output, thereby extending its life span.

The fuel cell system 820 in this embodiment normally restore the fuel cell group 801 to active condition after a predetermined inactive period. In case, however, where any of the fuel cell groups 801 does not restore an output even after the predetermined inactive period, the fuel cell group 801 in question may be isolated and the auxiliary power source 821 may be employed in place thereof. In this case, also, the fuel cell system 820 can similarly repeat the foregoing process of inactivating and activating the remaining fuel cell groups 801.

Further, the fuel cell system 820 may be alternatively constituted such that the auxiliary power source 821 can be utilized together with all the fuel cell groups 801. Such constitution permits constantly supplying a stable power to an external load through the use of the auxiliary power source 821, even when a power consumption of the external load 803 temporarily increases sharply, for example during a start-up phase of the external load 803. In addition, in this embodiment all the fuel cell groups 801 are respectively provided with an auxiliary power source 821, while just one auxiliary power source 821 may be provided in common for a plurality of fuel cell groups 801.

Third Embodiment

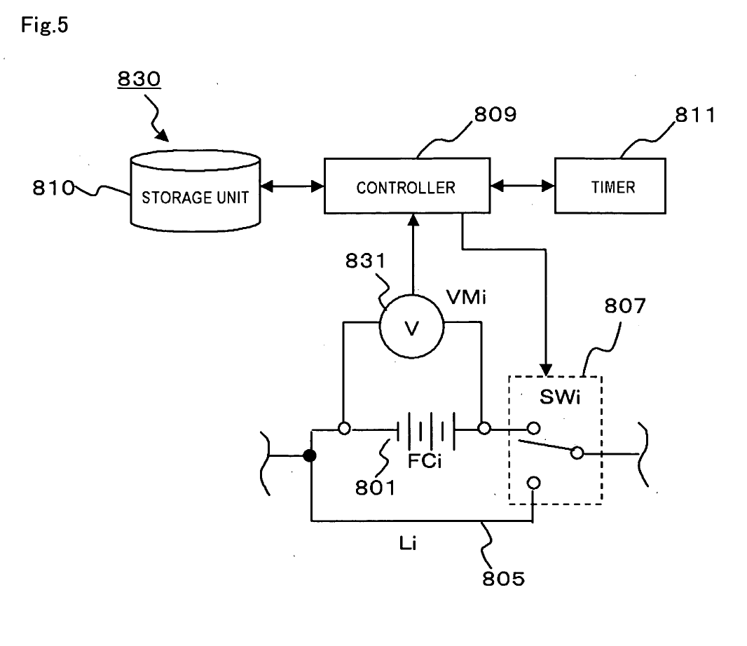

FIG. 5 is a fragmentary block diagram schematically showing a configuration of a third embodiment of the fuel cell system according to the present invention. The fuel cell system 830 in this embodiment is different from that of the first embodiment in further including a voltmeter 831 which measures a voltage of the fuel cell groups 801. Also, in this embodiment, the auxiliary power source 821 may be provided on the auxiliary line Li, as described in the second embodiment.

FIG. 5 shows only one out of the plurality of fuel cell groups 801, which is designated as “FCi” (i=1 to N, where N=4 in this embodiment). The voltmeter 831, designated as “VMi” in FIG. 5, is disposed at both ends of the i-th fuel cell group FCi.

The controller 809 monitors a voltage value of each fuel cell group FCi measured by the voltmeter VMi disposed on each fuel cell group FCi, and controls an operation of the fuel cell system 830 such that the fuel cell group FCi is electrically disconnected from the external load 803 in case where the voltage value drops below a predetermined threshold value, and that the disconnected fuel cell group FCi is restored to active condition in the fuel cell system 830, after a predetermined inactive period.

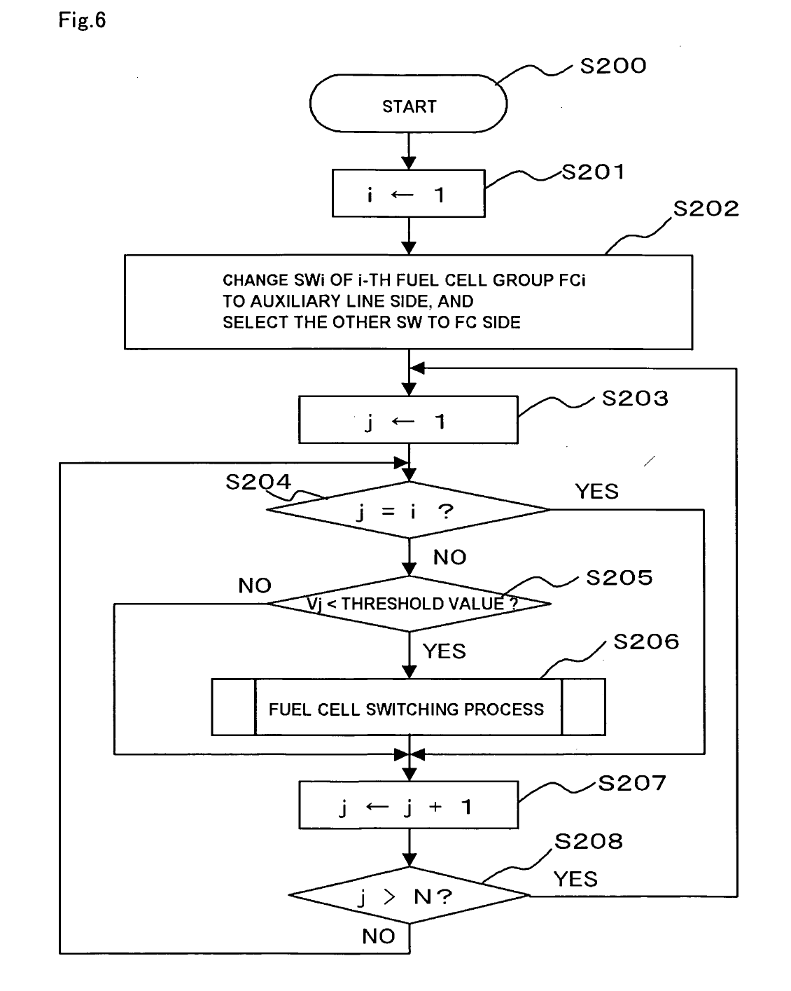

FIG. 6 is a flowchart showing an operating process of a controller of the fuel cell system shown in FIG. 5.

Firstly, when the system is activated (S200), 1 is set in i by the controller 809, as a first ID number of the fuel cell group 801 (S201). Here, the i-th fuel cell group FCi, which is designated by the ID number i, is the one that is electrically disconnected from the external load 803, thus to become inactive condition. Then the selector switch SWi of the i-th fuel cell group FCi is changed to the auxiliary line side and the selector switches of the remaining fuel cell groups are respectively changed to the fuel cell group side (S202). As a result, only the i-th fuel cell group FCi is electrically disconnected from the external load 803 and is inactivated.

Now the controller 809 sets 1 in j as a second ID number of the fuel cell group 801 (S203). Here, j can be any number from 1 to N, and the j-th fuel cell group FCj, which is designated by the second ID number j, is the one a voltage value of which is to be monitored by the controller 809 at a subsequent step. Thereafter it is decided whether j and i are identical (S204), and in case of j=i (YES of S204), the following steps of voltage measurement are skipped and the process advances to the step S207, since the j-th fuel cell group FCj is inactivated. On the other hand, in case of j is not equal to i (NO of S204), a voltage value Vj of the j-th fuel cell group FCj is read in via the voltmeter VMj, so that it is decided whether the voltage value Vj is lower than a predetermined threshold value (S205). In case of voltage value Vj is not less than threshold value (NO of S205), the next step is skipped and the process advances to the step S207. On the other hand, in case of voltage value Vj is less than threshold value (YES of S205), the controller 809 transfers the process to fuel cell switching process (S206), which will be later described. Then once the controller 809 returns the process from the fuel cell switching process, j is incremented (S207), and it is decided whether j is greater than N, which is the number of the fuel cells (S208). In case of j is greater than N (YES of S208), the process returns to the step S203, and the 1 is set as j. By contrast, in case of j is no more than N (NO of S208), the process returns to the step S204.

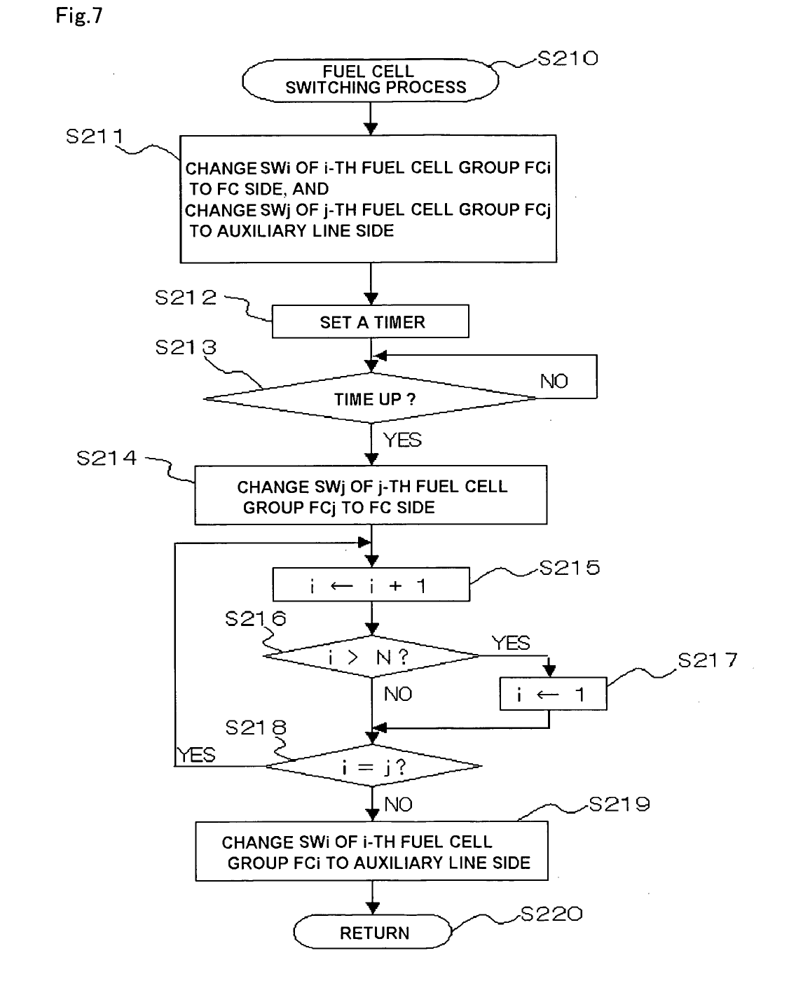

FIG. 7 is a flowchart showing a process of the fuel cell switching process included in FIG. 6.

When the process is transferred from FIG. 6 (S210), the selector switch SWi of the i-th fuel cell group FCi is changed to the fuel cell group side, and the selector switch SWj of the j-th fuel cell group FCj is changed to the auxiliary line Lj side (S211). This causes the j-th fuel cell group FCj, which is outputting a voltage Vj lower than the threshold value, to be electrically disconnected from the external load 803 and inactivated, and in turn causes the i-th fuel cell group FCi, which has been inactivated, to be activated in place of the j-th fuel cell group FCj.

Then the controller 809 instructs the timer 811 to start a timekeeping operation, so that the timer 811 starts to measure a predetermined length of time (S212). The controller 809 monitors the timer 811 (S213), and when the predetermined time has elapsed (YES of S213), the selector switch SWj of the j-th fuel cell group FCj is changed to the fuel cell group side (S214).

Thereafter i is incremented (S215), and it is decided whether i is greater than N (S216). In case of i is more than N (YES of S216), 1 is set as i (S217).

On the other hand, in case of i is no more than N (NO of S216), it is decided whether i is equivalent to j (S218), and in case of i is identical to j (YES of S218) the control is returned to the step S215, where i is further incremented. However, in case of i is not identical to j (NO of S218), the selector switch SWi of the i-th fuel cell group FCi is changed to the auxiliary line side (S219). This causes the j-th fuel cell group FCj, which has been inactivated for a predetermined time, to resume its activity in the fuel cell system 830, and in turn causes the i-th fuel cell group FCi to be electrically disconnected from the external load 803, thus to become inactive condition. Then the controller 809 returns the process shown in FIG. 6 (S220).

An operation of the fuel cell system 830 constituted as above in this embodiment will be described referring to FIGS. 5 to 7.

Referring to FIG. 6, once the system is activated (S200), the controller 809 defines as i=1 (S201). Then the first fuel cell group FC1 is selected as the one to be first inactivated, and the selector switch SW1 is changed to the auxiliary line L1 side (S202).

Then 1 is set as the second ID number j corresponding to a fuel cell a voltage value of which is to be monitored (S203). Here, since j is equivalent to the first ID number i, the process advances from the step S204 to the step S207, where j is incremented to become 2. At this point, j is not greater than N (N=4) (NO of S208), but not equivalent to i either (NO of S204). Accordingly, a voltage value V2 of the second fuel cell group FC2 is read in via the voltmeter VM2, and it is decided whether the voltage value V2 is lower than the threshold value (S205). In case of voltage value V2 is not less than threshold value (NO of S205), the process advances to the step S207, where j is incremented to become 3. Here, since j is not greater than N (N=4) (NO of S208), but not equivalent to i either (NO of S204), a voltage value V3 of the third fuel cell group FC3 is read in via the voltmeter VM3, and it is decided whether the voltage value V3 is lower than the threshold value (S205). Then in case of voltage value V3 is less than threshold value (YES of S205), the controller 809 transfers the process to the fuel cell switching process (S206).

In the fuel cell switching process shown in FIG. 7, the selector switch SW1 of the first fuel cell group FC1 is changed to the fuel cell group FC1 side, and the selector switch SW3 of the third fuel cell group FC3 is changed to the auxiliary line L3 side (S211). This causes the third fuel cell group FC3, which is outputting a voltage lower than the threshold value, to be electrically disconnected from the external load 803 and thus to become inactive condition, and in turn causes the first fuel cell group FC1, which has been inactivated, to resume its activity in the fuel cell system 830, in place of the third fuel cell group FC3.

Then the third fuel cell group FC3 is held inactive for a predetermined time measured by the timer 811 (S212, S213), after which the selector switch SW3 of the third fuel cell group FC3 is changed to the fuel cell group side (S214). At this point i is incremented to become 2 (S215). Here, since i is not greater than N (NO of S216), but not equivalent to j either (NO of S218), the selector switch SW2 of the second fuel cell group FC2 is changed to the auxiliary line L2 side (S219). This causes the third fuel cell group FC3 to resume its activity in the fuel cell system 830, and the second fuel cell group FC2 to be electrically disconnected from the external load 803, thus to become inactive condition. Then the controller 809 returns the control to the process shown in FIG. 6 (S220).

Referring back to FIG. 6, j is incremented to become 4 (S207). Now, since i is not greater than N (NO of S216), but not equivalent to j either (NO of S218), a voltage value V4 of the fourth fuel cell group FC4 is read in via the voltmeter VM4, and it is decided whether the voltage value V4 is lower than the threshold value (S205). In case of voltage value V4 is not less than threshold value (NO of S205), the process advances to the step S207, where J is incremented to become 5. Then since j is greater than N (YES of S208), the process advances to the step S203, where 1 is set as j. Now since j is not equivalent to i (NO of S204), the voltage value V1 of the first fuel cell group FC1 is read in via the voltmeter VM1, and it is decided whether the voltage value V1 is lower than the threshold value (S205).

In this way the voltage value of the active fuel cell group is sequentially read in and monitored, so that in case where a voltage proves to be lower than the threshold value the corresponding fuel cell group is electrically disconnected from the external load 803 thus to become inactive condition. Further, the fuel cell group that has been inactivated is restored to the active condition after a predetermined period of time, and another fuel cell group is inactivated instead.

As described above, the fuel cell system 830 in this embodiment can monitor a voltage value of each fuel cell group 801. Accordingly, the fuel cell system 830 can identify the fuel cell group 801 that is outputting a voltage lower than a threshold value and inactivate such fuel cell group for a predetermined time, so that the fuel cell group can restore an output during the inactive period. Consequently, the fuel cell groups can maintain a stable output unlike a case of long hours of continuous use, and resultantly a life span of the fuel cell group can be extended. Meanwhile, a sequence in which the fuel cell groups are to be inactivated is not limited to the foregoing arrangement, and a sequence in which a voltage value of the fuel cell groups is to be monitored is not limited thereto either. For example, a voltage value of a fuel cell group that has not been inactivated may be sequentially measured at certain intervals, so as to select a fuel cell group that is outputting the lowest voltage value and to inactivate that fuel cell group.

Fourth Embodiment

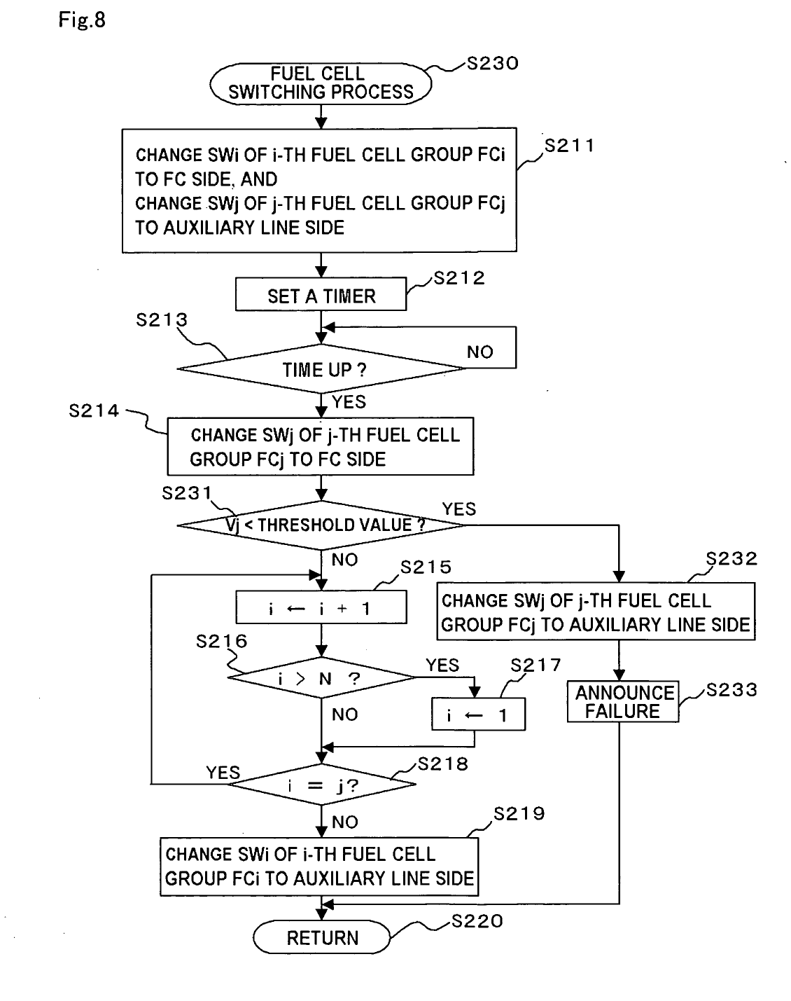

FIG. 8 is a flowchart showing a process of the fuel cell switching process in a fourth embodiment of the fuel cell system according to the present invention. This embodiment is different from the third embodiment in that the operating process includes detecting a failure of a fuel cell group, and isolating the fuel cell group that has failed from the fuel cell system.

As shown in FIG. 8, the fuel cell switching process (S230) of the fuel cell system in this embodiment further includes the steps of detecting a failure of the fuel cell group that has been restored to active condition (S231 to S233), after the step S214 shown in FIG. 7.

More specifically, a voltage value Vj of the j-th fuel cell group FCj is read in via the voltmeter VMj, and it is decided whether the voltage value Vj is lower than a predetermined threshold value (S231). In case of voltage value Vj is not less than threshold value (NO of S231), the process advances to the step S215. On the other hand, in case of voltage value Vj is less than threshold value (YES of S231), the selector switch SWj of the j-th fuel cell group FCj is changed to the auxiliary line Lj side (S232). This causes the j-th fuel cell group FCj, which is outputting a voltage value Vj lower than the threshold value, to be electrically disconnected from the external load 803. Here, the auxiliary line Lj may be provided with an auxiliary power source such as a spare fuel cell group. Then an announcement is made to the effect that the fuel cell group has failed (S233), and the control is returned to the process shown in FIG. 6 (S220).

Such arrangement permits detecting a failure of the fuel cell group FCj in view of no recovery of its characteristic such as an output voltage value despite having been inactivated for a predetermined time, and thereby isolating the fuel cell group FCj from the fuel cell system.

Meanwhile, once a failure of the j-th fuel cell group FCj has been detected and the fuel cell group FCj has been electrically disconnected from the external load 803, the subsequent process specified in FIGS. 6 and 8 are skipped with respect to the j-th fuel cell group FCj that has failed, though further details will not be described herein. In other words, the process shown in FIGS. 6 and 8 are performed only with respect to the remaining fuel cell groups.

A constitution of an announcing unit which notifies the failure in the step S233 is not specifically limited. Various devices are applicable, including an alarm signal output to an external device, an alarm display device such as an LED (not shown), a display via an LCD panel, an auditory alarm output via a speaker (not shown), and so forth.

Also, in case where a spare fuel cell group is provided, the announcement of failure may be made only when the spare fuel cell group has failed. Further, in case where a plurality of spare fuel cell groups are provided, the announcement may be made at a stage where a remaining number of normal spare fuel cell groups has decreased to a predetermined level. In addition, with respect to a fuel cell group that does not restore its characteristic such as an output voltage value despite having been inactivated for a predetermined time, the inactive period may be extended to make sure whether the fuel cell group in question has failed or not. Then the announcement may be made after repeating the foregoing process without achieving a restoration of the characteristic of the fuel cell group such as an output voltage.

An operation of the fuel cell system constituted as above in this embodiment will be described referring to FIG. 8.

Here, it is to be assumed that the first fuel cell group FC1 is currently inactivated, and a voltage value V3 of the third fuel cell group FC3 has proved to be lower than a threshold value. In the fuel cell switching process (S230), the selector switch SW1 of the first fuel cell group FC1 is changed to the fuel cell group FC1 side, and the selector switch SW3 of the third fuel cell group FC3 is changed to the auxiliary line L3 side (S211). This causes the third fuel cell group FC3, which is outputting the voltage value lower than the threshold value, to be electrically disconnected from the external load 803 and thus to become inactive condition, and in turn causes the first fuel cell group FC1 that has been inactivated to be restored to the active condition in the fuel cell system 830.

Then the third fuel cell group FC3 is held inactive for a predetermined time measured by the timer 811 (S212, S213), after which the selector switch SW3 of the third fuel cell group FC3 is changed to the fuel cell group side (S214). And a voltage value V3 of the third fuel cell group FC3 is read in via the voltmeter VM3, and it is decided whether the voltage value V3 is lower than the threshold value (S231).

Here, in case of voltage value VM3 is not less than threshold value (NO of S231), the process advances to the step S215, where an operation similar to the third embodiment is performed. Consequently the second fuel cell group FC2 is electrically disconnected from the external load 803, thus to became inactive condition.

On the other hand, in case where the voltage value VM3 is lower than the threshold value (YES of S231), the selector switch SW3 of the third fuel cell group FC3 is changed to the auxiliary line L3 side (S232). This causes the third fuel cell group FC3, which is outputting the voltage value lower than the threshold value, to be electrically disconnected from the external load 803. Then the announcement is made to the effect that the fuel cell group has failed (S233), and the current process is terminated so that the control is returned to the main process (S220).

As described above, the fuel cell system 830 in this embodiment makes the fuel cell group 801 inactive for a predetermined time in case where the voltage value thereof is lower than the threshold value. Then the fuel cell system 830 rechecks the voltage value of the fuel cell group upon making it back active condition, so as to decide that the fuel cell group has failed in case where the voltage value has not been restored, and to isolate the fuel cell group from the system. Such arrangement upgrades reliability of the fuel cell system.

Fifth Embodiment

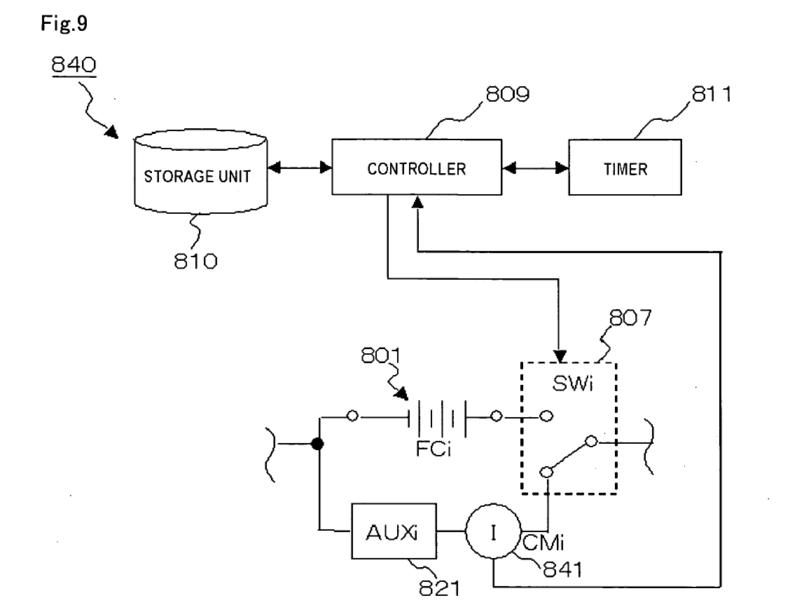

FIG. 9 is a fragmentary block diagram schematically showing a configuration of a fifth embodiment of the fuel cell system according to the present invention. The fuel cell system 840 in this embodiment is different from that of the second embodiment in further including an ammeter 841 which measures an integrated current value of the fuel cell group 801.

FIG. 9 shows only one out of the plurality of fuel cell groups 801, which is designated as “FCi” (i=1 to N, where N=4 in this embodiment). The fuel cell system 840 is provided with an ammeter 841 electrically connected in series to the auxiliary power source 821, which is connected in parallel to the fuel cell group FCi. In FIG. 9, the auxiliary power source 821 is designated as “AUXi”, and the ammeter 841 as “CMi”. Here, the integrated current value of the fuel cell system 840 can be measured by the ammeter CMi provided to the fuel cell group FCi, which has been electrically disconnected from the external load 803 and become inactive condition. Also, while this embodiment represents a constitution where the plurality of fuel cell groups 801 is respectively provided with the ammeter 841, the fuel cell system 840 may include just one ammeter 841. In this case, the ammeter 841 may be disposed between the fuel cell group 801 and the external load 803, for example in the fuel cell system 800 shown in FIG. 1.

Also, in another embodiment, there may be provided a resistance electrically connected in series to the auxiliary power source 821 and a voltmeter disposed on the resistance for measuring a voltage value on both sides of the resistance.

The controller 809 reads in a current value measured by one of the ammeter CMi provided for each fuel cell group FCi, to thereby calculate an integrated current value.

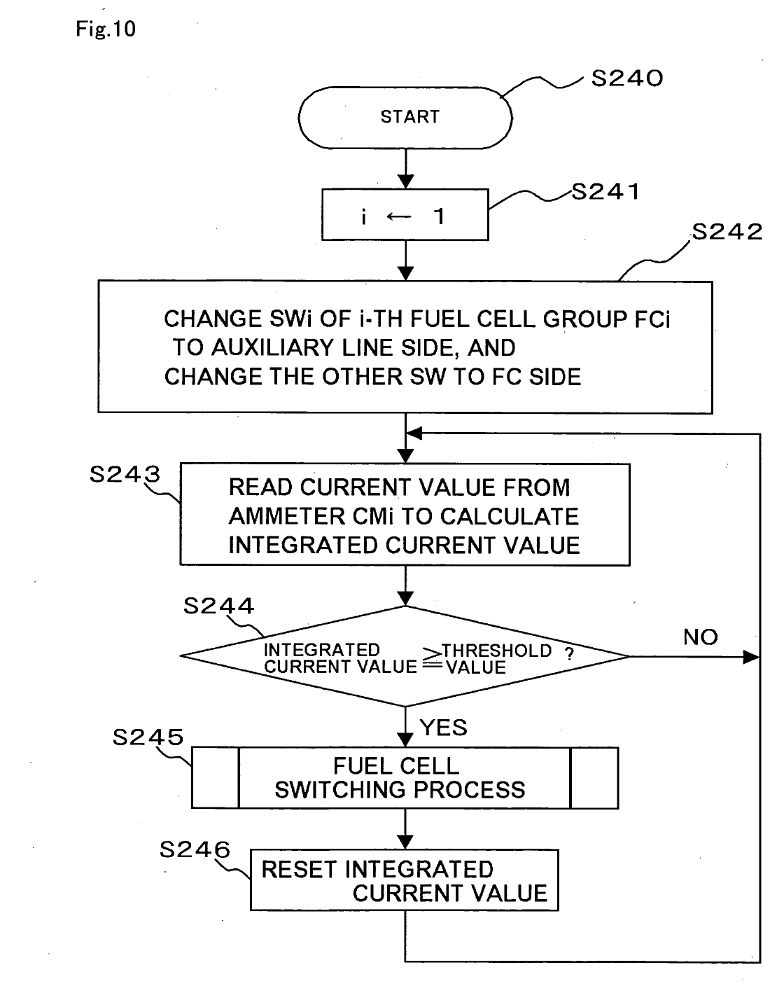

FIG. 10 is a flowchart showing an operating process of a controller of the fuel cell system shown in FIG. 9.

Firstly, when the system is activated (S240), 1 is set in i by the controller 809 (S241). Here, the i-th fuel cell group FCi, which is designated by the ID number i, is the one that is electrically disconnected from the external load 803, thus to become inactive condition. Then the selector switch SWi of the i-th fuel cell group FCi is changed to the auxiliary line side and the selector switches of the remaining fuel cell groups are respectively changed to the fuel cell group side (S242). As a result, only the i-th fuel cell group FCi is electrically disconnected from the external load 803 and becomes inactive condition.

Then the current value Ii, being supplied to the auxiliary power source AUXi incorporated in the fuel cell system 840 in place of the i-th fuel cell group FCi which is inactivated, is read in via the ammeter CMi, so that the integrated current value is calculated (S243). Then it is decided whether the obtained integrated current value is equal to or greater than a predetermined threshold value (S244). In case of integrated current value is less than threshold value (NO of S244), the process returns to the step S243. On the other hand, in case of integrated current value is not less than threshold value (Yes of S244), the process is transferred to the fuel cell switching process to be later described (S245). Then once the control is returned from the fuel cell switching process, the integrated current value is reset (S246), and the process returns to the step S243.

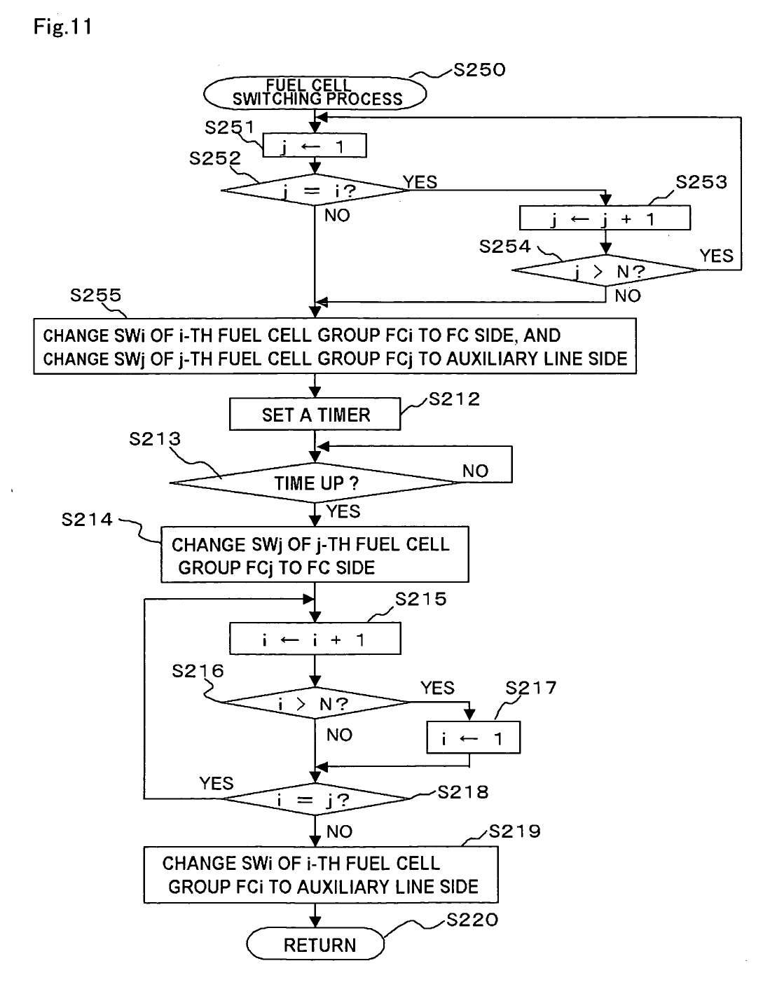

FIG. 11 is a flowchart showing a process of the fuel cell switching process included in FIG. 10.

When the control is transferred from the process shown in FIG. 10 (S250), the controller 809 sets 1 in j as a second ID number of the fuel cell group 801 (S251). Here, j can be any number from 1 to N. Also, the j-th fuel cell group PCj, which is designated by the second ID number j, is the one that is to be inactivated for a predetermined time in a subsequent step. Thereafter it is decided whether j and i are identical (S252), and in case of j=i (YES of S252), j is further incremented (S253) since the j-th fuel cell group FCj is inactivated, and it is decided whether j is greater than N, which is the number of the fuel cells (S254). In case of j is more than N (YES of S254), the process returns to the step S251, and the 1 is set as j. By contrast, in case of j is not more than N (NO of S254), the selector switch SWi of the i-th fuel cell group FCi is changed to the fuel cell group side, and the selector switch SWj of the j-th fuel cell group FCj is changed to the auxiliary power source side (S255). This causes the i-th fuel cell group FCi, which has been inactivated, to be restored to the active condition in the fuel cell system 840, and in turn causes the j-th fuel cell group FCj to be electrically disconnected from the external load 803, thus to become inactive condition.

Since the subsequent process is similar to that of the fuel cell switching process shown in FIG. 7, the description thereof win be omitted.

An operation of the fuel cell system 840 constituted as above in this embodiment will be described referring to FIGS. 9 to 11.

As shown in FIG. 10, once the system is activated (S240), the controller 809 defines as i=1 (S241). Then the first fuel cell group FC1 is selected as the one to be first inactivated, and the selector switch SW1 is changed to the auxiliary power source AMX1 side and the selector switches of the remaining fuel cells are changed to the fuel cell group side (S242).

Then the current value I1, being supplied to the auxiliary power source AMX1 incorporated in the fuel cell system 840 in place of the first fuel cell group FC1 which is inactivated, is read in via the ammeter CM1, so that the integrated current value is calculated (S243). Then it is decided whether the obtained integrated current value is equal to or greater than the predetermined threshold value (S244).

In case of integrated current value is less than threshold value (NO of S244), the control is returned to the step S243, and the integrated current value is continuously monitored. On the other hand, in case of integrated current value is not less than threshold value (Yes of S244), the control is transferred to the fuel cell switching process (S245).

In the fuel cell switching process of FIG. 11, 1 is set as j (S251), and since j is equivalent to i which is 1 (YES of S252), j is incremented to became 2 (S253), and now since j is smaller than N which is 4 (NO of S254), the process advances to the step S255.

The selector switch SW1 of the first fuel cell group FC1 is changed to the fuel cell group side, and the selector switch SW2 of the second fuel cell group FC2 is changed to the auxiliary power source AUX2 side (S255). This causes the first fuel cell group FC1, which has been inactivated, to be restored to active condition in the fuel cell system 840, and in turn causes the second fuel cell group FC2 to be electrically disconnected from the external load 803, thus to become inactive condition.

Then the second fuel cell group FC2 is held inactive for a predetermined time measured by the timer 811 (S212, S213), after which the selector switch SW2 of the second fuel cell group FC2 is changed to the fuel cell group side (S214). Now i is incremented to became 2 (S215), and since i is not greater than N (NO of S216), but is equivalent to j, the control is returned to the step S215.

At the step S215 i is again incremented to become 3, and since i is not greater than N (NO of S216), but not equivalent to j either (NO of S218), the selector switch SW3 of the third fuel cell group FC3 is changed to the auxiliary power source AUX3 side (S219). This causes the second fuel cell group FC2 to be restored to active condition in the fuel cell system 840, and the third fuel cell group FC3 to be electrically disconnected from the external load 803, thus to become inactive condition. Then the control is returned to the process shown in FIG. 10 (S220).

Referring back to FIG. 10, the integrated current value is reset. (S246) and the process returns to the step S243, so that the integrated current value is continuously monitored. Meanwhile, monitoring the integrated current value may be performed in parallel to the process shown in FIG. 11.

Likewise, thereafter a portion of the plurality of fuel cell groups is sequentially made inactive condition, when the integrated current value reaches or exceeds the threshold value.

As described above, the fuel cell system 840 in this embodiment can monitor the integrated current value, and can sequentially inactivate a portion of the fuel cell groups for a predetermined time when the integrated current value reaches or exceeds a threshold value, so that the fuel cell group can restore an output during the inactive period. Consequently, the fuel cell groups can maintain a stable output unlike a case of long hours of continuous use, and resultantly a life span of the fuel cell group can be extended.

Sixth Embodiment

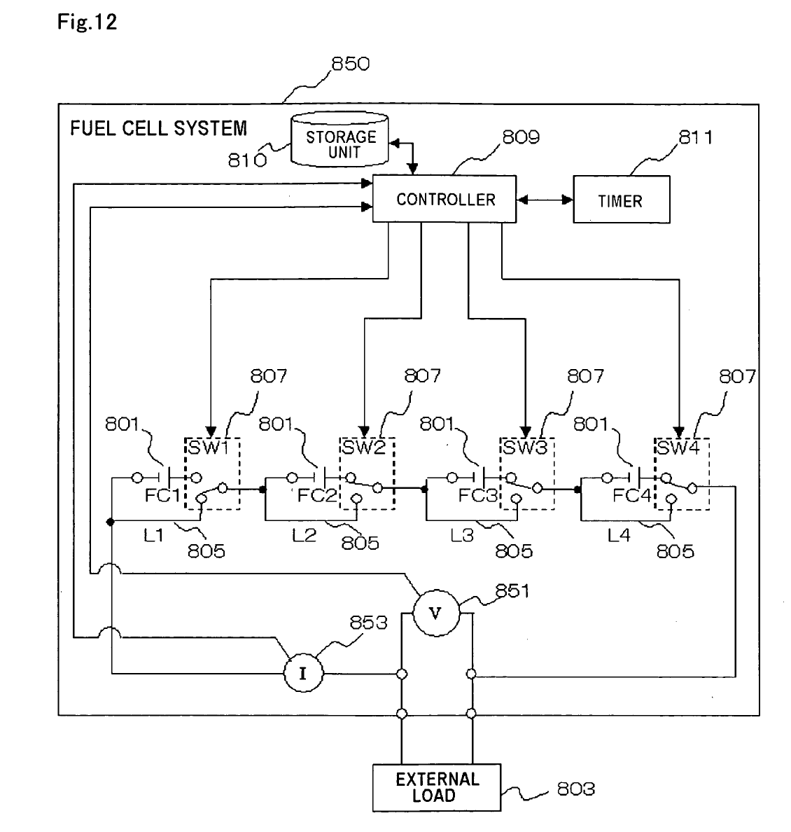

FIG. 12 is a block diagram schematically showing a configuration of a sixth embodiment of the fuel cell system according to the present invention. The fuel cell system 850 in this embodiment is different from that of the first embodiment in further including a voltmeter 851 which measures a voltage value applied to the external load 803, and an ammeter 853 which measures a current value supplied to the external load 803.

The controller 809 reads in a voltage value and a current value respectively measured by the voltmeter 851 and the ammeter 853, to thereby calculate a power being supplied by the fuel cell system to the external load 803. The controller 809 controls an operation of the fuel cell groups 801 to supply a necessary power to the external load 803, by activating a portion of the plurality of fuel cell groups 801.

While the fuel cell system 850 in this embodiment includes four sets of fuel cell groups 801, the system is preferably capable of supplying a power which, for example, satisfies a need of the external load 803 under its normal operating status, without activating all the available fuel cell groups 801. The controller 809 monitors the power being generated by the fuel cell system 850, so as to inactivate a portion of the fuel cell groups 801 when the power reaches or exceeds an amount required by the external load 803, and controls the remaining fuel cell groups 801 so as to supply a necessary power to the external load 803.

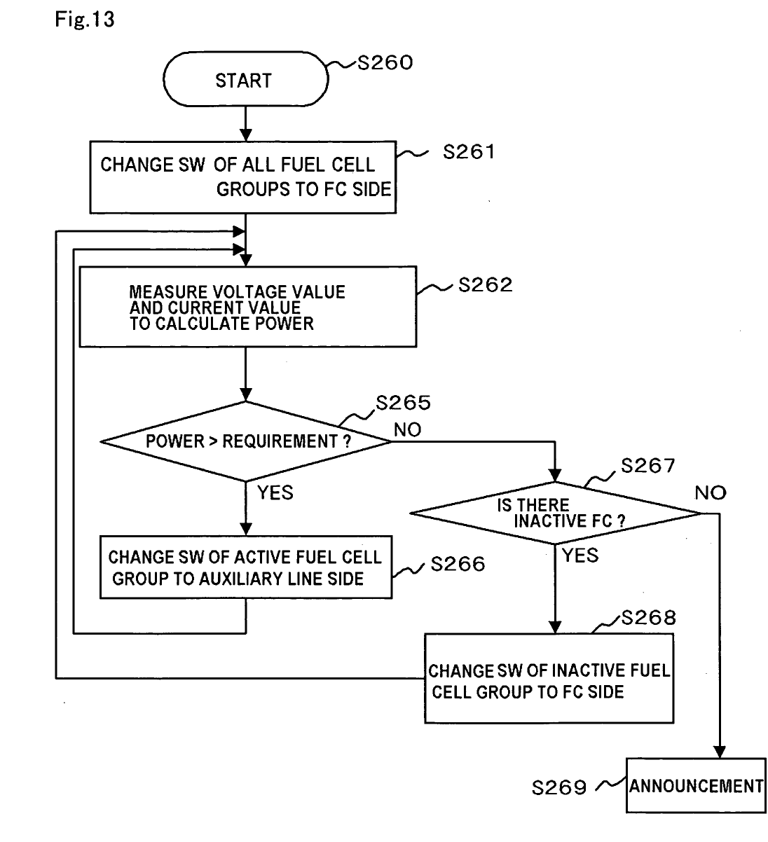

FIG. 13 is a flowchart showing an operating process of a controller of the fuel cell system shown in FIG. 12.

Firstly, when the system is activated (S260), the selector switches 807 of all the fuel cell groups 801 are changed to the fuel cell group side (S261). Then the voltage value and the current value are read in via the voltmeter 851 and the ammeter 853 respectively, so that the power is calculated based on the voltage value and the current value that have been read in (S262). After that, it is decided whether the calculated power is greater than a requirement of the external load 803 (S265). In case where the power is greater than the requirement (YES of S265), the selector switch of any one of the working fuel cell groups is changed to an auxiliary line side (S266), and the process returns to the step 262.

On the other hand, in case where the calculated power is less than the requirement (NO of S265), it is checked whether any of the fuel cell groups is currently inactivated (S267), and in case where one or more are available (YES of S267), the selector switch of the fuel cell group out of those which are inactivated is changed to the fuel cell group side (S268), and the process returns to the step 262. At the step 267, in case where the fuel cell group that is inactivated is unavailable (NO of S267), an announcement is made to the effect that the fuel cell group has failed (S269). Through repeating such processes, the fuel cell system 850 becomes capable of supplying a necessary power to the external load 803.

As described above, the fuel cell system 850 in this embodiment measures and monitors a power being supplied to the external load 803, to thereby inactivate a portion of the fuel cell groups or restore it to active condition based on the monitoring result. Accordingly, a portion of the fuel cell groups can be inactivated while maintaining a necessary output for the external load 803, so that the fuel cell group can restore an output during the inactive period. Consequently, the fuel cell groups can maintain a stable output unlike a case of long hours of continuous use, and resultantly a life span of the fuel cell group can be extended.

Further, while the fuel cell group is inactivated one by one in this embodiment, the present invention is not limited to such arrangement. For example, a plurality of fuel cell groups may be inactivated or activated at a time. Also, the fuel cell group to be made inactive condition may be sequentially selected and replaced one after another at certain intervals.

Furthermore, as shown in FIG. 5 representing the third embodiment, the fuel cell groups 801 may be respectively provided with a voltmeter which measures a voltage thereof. Under such constitution, in case where a total power being generated by all of the fuel cell groups 801 is greater than a requirement of the external load 803, the fuel cell group that is outputting the lowest voltage among the plurality of fuel cell groups 801 may be sequentially selected to be inactivated.

Seventh Embodiment

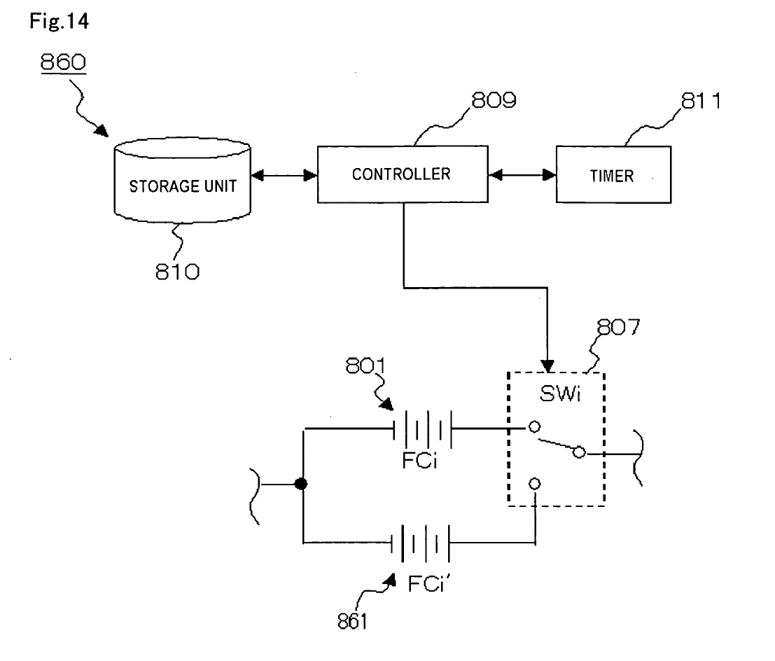

FIG. 14 is a fragmentary block diagram schematically showing a configuration of a seventh embodiment of the fuel cell system according to the present invention. The fuel cell system 860 in this embodiment is different from that of the first embodiment in including a plurality of second fuel cell groups 861, instead of the corresponding auxiliary lines 805 provided in parallel to the fuel cell groups 801.

In FIG. 14, each of the second fuel cell groups 861 is designated as “FCi′”, and the i-th second fuel cell group will also be hereinafter designated as “FCi′”.

In this embodiment of the fuel cell system 860, when the selector switch SWi of the i-th fuel cell group FCi is changed to the second fuel cell group side to thereby inactivating the i-th fuel cell group FCi , the i-th second fuel cell group FCi′ is employed in place of the i-th fuel cell group FCi. Accordingly, since the generated power does not decline despite that the i-th fuel cell group FCi is inactivated, the stable output can be maintained.

The only difference in operating process of the controller 809 of the fuel cell system 860 in this embodiment from that of the first embodiment is that the selector switch SWi of the i-th fuel cell group FCi is changed to the second fuel cell group side in the step S102. Therefore, detailed description will be omitted.

In this embodiment, the second fuel cell groups 861 are provided for all the four fuel cell groups 801, however without limiting to such constitution the second fuel cell groups 861 may be provided in parallel to at least a portion of the fuel cell groups 801. Also, a plurality of fuel cell groups 801 may be inactivated at a time, to be substituted with the second fuel cell group 861. Alternatively, in another embodiment, at least one second fuel cell group 861 may be provided for the four fuel cell groups 801, so that the second fuel cell group 861 may be substituted for at least one of the fuel cell groups 801 that is inactivated.

Further, in this embodiment the second fuel cell group 861 is provided in place of the auxiliary line 805 of the first embodiment, while the second fuel cell group 861 may be provided in parallel to at least a portion of the fuel cell groups 801 in another embodiment.

As described above, the fuel cell system 860 in this embodiment is provided with the second fuel cell groups 861 arranged in parallel to the respective fuel cell groups 801. Accordingly, in addition to the advantages offered by the foregoing embodiments, since the second fuel cell group FCi′ can be employed while the i-th fuel cell group FCi is inactivated, a generated power does not decline despite that the i-th fuel cell group FCi is inactivated, and therefore a stable output can be maintained. Further, since the second fuel cell group FCi′ can be inactivated while the i-th fuel cell group FCi is activated, a life span of the second fuel cell group FCi′ can also be extended.

1. A fuel cell system comprising:
a plurality of fuel cell groups which supply a power to an external load;
a selection unit which selects at least one fuel cell group out of said plurality of fuel cell groups; and
a connector which electrically disconnects said fuel cell group selected by said selection unit from said external load, and electrically connects another fuel cell group to said external load.

2. The fuel cell system as set forth in claim 1, further comprising
a storage unit which stores a process information on which said selection unit selects a fuel cell group to be electrically disconnected from said external load, wherein
said selection unit selects a fuel cell group to be electrically disconnected from said external load according to said process information stored in said storage unit.

3. The fuel cell system as set forth in claim 2, wherein
said storage unit stores an order in which said selection unit selects a fuel cell group, and
said selection unit sequentially selects a fuel cell group to be electrically disconnected from said external load according to said order stored in said storage unit.

4. The fuel cell system as set forth in claim 1, wherein
said selection unit selects a fuel cell group to be electrically disconnected from said external load according to an operating status of said plurality of fuel cell groups.

5. The fuel cell system as set forth in claim 1, further comprising
a monitoring unit which monitors an operating status of each individual fuel cell group, wherein
said selection unit selects a fuel cell group to be electrically disconnected from said external load according to said operating status provided by said monitoring unit.

6. The fuel cell system as set forth in claim 5, wherein
said monitoring unit includes a voltage measuring unit which measures an output voltage of each individual fuel cell group, and
said selection unit selects a fuel cell group to be electrically disconnected from said external load according to said output voltage measured by said voltage measuring unit.

7. The fuel cell system as set forth in claim 1, further comprising:
a monitoring unit which monitors an operating status of said plurality of fuel cell groups; and
a decision unit which decides whether or not to electrically disconnect at least one fuel cell group from said external load according to said operating status provided by said monitoring unit, wherein
said selection unit selects a fuel cell group to be electrically disconnected from said external load when said decision unit has decided to electrically disconnect at least one fuel cell group from said external load.

8. The fuel cell system as set forth in claim 7, wherein
said monitoring unit includes a current value measuring unit which measures a current value of a plurality of fuel cell groups, and
said decision unit decides whether or not to electrically disconnect at least one fuel cell group from said external load, according to the current value measured by said current value measuring unit.

9. The fuel cell system as set forth in claim 7, wherein
said monitoring unit includes a power measuring unit which measures a power being supplied to said external load by said plurality of fuel cell groups, and
said decision unit decides whether or not to electrically disconnect at least one fuel cell group from said external load, according to the power measured by said power measuring unit.

10. The fuel cell system as set forth in claim 5, further comprising
an announcing unit which announces a monitoring result provided by said monitoring unit.

11. The fuel cell system as set forth in claim 1, further comprising
a time keeping unit, wherein
said connector electrically connects to said external load said fuel cell group that has been electrically disconnected therefrom, after a predetermined time since said fuel cell group was electrically disconnected from said external load.

12. The fuel cell system as set forth in claim 1, further comprising
a time keeping unit, wherein
said selection unit sequentially selects a fuel cell group to be electrically disconnected from said external load, each time a predetermined time elapses.

13. The fuel cell system as set forth in claim 1, wherein
said plurality of fuel cell groups is mutually connected in series, and
said connector includes an auxiliary line provided in parallel to said plurality of fuel cell groups, and a selector switch which electrically connects another fuel cell group to said external load via said auxiliary line when the fuel cell group selected by said selection unit has been electrically disconnected from said external load.

14. The fuel cell system as set forth in claim 13, further comprising an auxiliary power source provided for said auxiliary line, for supplying power to said external load.

15. A fuel cell system comprising:
a plurality of fuel cell groups which supply a power to an external load; and
a monitoring unit which monitors an operating status of each individual fuel cell group.

16. The fuel cell system as set forth in claim 15, wherein
said monitoring unit includes a voltage measuring unit which measures an output voltage of each individual fuel cell group.

17. A method of operating a fuel cell system comprising:
selecting at least one fuel cell group out of a plurality of fuel cell groups which supply a power to an external load;
electrically disconnecting from said external load said fuel cell group that has been selected in said step of selecting; and
electrically connecting another fuel cell group to said external load.

18. The method as set forth in claim 17, wherein
said step of selecting the fuel cell group includes selecting a fuel cell group to be electrically disconnected from said external load according to a predetermined process.

19. The method as set forth in claim 17, wherein
said step of selecting the fuel cell group includes sequentially selecting a fuel cell group to be electrically disconnected from said external load according to a predetermined order.

20. The method as set forth in claim 17, further comprising
monitoring an operating status of each individual fuel cell group, wherein
said step of selecting the fuel cell group includes selecting a fuel cell group to be electrically disconnected from said external load according to the operating status of each individual fuel cell group.

21. The method as set forth in claim 20, wherein
said step of monitoring the operating status of each individual fuel cell group includes measuring an output voltage of each fuel cell group, and
said step of selecting the fuel cell group includes selecting a fuel cell group to be electrically disconnected from said external load according to the output voltage measured in said step of measuring the output voltage.

22. The method as set forth in claim 17, further comprising
monitoring an operating status of said plurality of fuel cell groups, wherein
said step of selecting the fuel cell group includes selecting a fuel cell group to be electrically disconnected from said external load according to said operating status of said plurality of fuel cell groups.

23. The method as set forth in claim 17, further comprising:
monitoring an operating status of said plurality of fuel cell groups; and
deciding whether or not to electrically disconnect at least one fuel cell group from said external load out of said plurality of fuel cell groups; wherein
said step of selecting the fuel cell group includes selecting a fuel cell group to be electrically disconnected from said external load when it has been decided to electrically disconnect at least one fuel cell group from said external load in said step of deciding.

24. The method as set forth in claim 23, wherein
said step of monitoring the operating status includes measuring a current value of said plurality of fuel cell groups, and
said step of deciding includes deciding whether or not to electrically disconnect at least one fuel cell group from said external load, according to the current value measured in said step of measuring the current value.

25. The method as set forth in claim 22, wherein
said step of monitoring the operating status includes measuring a power being supplied to said external load, and
said step of deciding includes deciding whether or not to electrically disconnect at least one fuel cell group from said external load, according to the power measured in said step of measuring the power.

26. The method as set forth in claim 20, further comprising
announcing a monitoring result obtained in said step of monitoring the operating status.

27. The method as set forth in claim 17, further comprising:
detecting a lapse of a predetermined time after said fuel cell group has been electrically disconnected from said external load in said step of electrically disconnecting the fuel cell group from said external load; and
electrically connecting said fuel cell group to said external load after said predetermined time has elapsed.

28. The method as set forth in claim 17, further comprising
detecting a lapse of a predetermined time after the fuel cell group has been electrically disconnected from said external load in said step of electrically disconnecting the fuel cell group from said external load, wherein
said step of selecting the fuel cell group includes sequentially selecting a fuel cell group to be electrically disconnected from said external load each time said predetermined time elapses.

29. A method of operating a fuel cell system comprising
monitoring an operating status of each individual fuel cell group included in said plurality of fuel cell groups which supply a power to said external load.

30. The method as set forth in claim 29, wherein
said step of monitoring the operating status includes measuring an output voltage of each individual fuel cell group.

31. A program for execution of the method as set forth in claims 17, applicable to a fuel cell system comprising a plurality of fuel cell groups which supply a power to an external load wherein said plurality of fuel cell groups can be electrically connected and disconnected to said external load.

32. A storage medium containing the program as set forth in claim 31.
